(19) United States
(12) Patent Application Publication
(10) Pub. No.: US 2021/0304211 A1
(43) Pub. Date: Sep. 30, 2021

(54) INFORMATION PROCESSING METHOD, INFORMATION PROCESSING SYSTEM, AND INFORMATION PROCESSING APPARATUS

(71) Applicant: FUJITSU LIMITED, Kawasaki-shi (JP)

(72) Inventor: Makoto Goda, Warabi (JP)

(73) Assignee: FUJITSU LIMITED, Kawasaki-shi (JP)

(21) Appl. No.: 17/193,792

(22) Filed: Mar. 5, 2021

(30) Foreign Application Priority Data
Mar. 31, 2020 (JP) 2020-065123

(51) Int. Cl. G06Q 20/40

(52) U.S. Cl. CPC G06Q 20/40145

(57) ABSTRACT

An information processing method that causes a computer to execute a process, the process includes receiving one or more terminal information transmitted from one or more mobile terminal whose position with respect to the computer satisfy a condition, transmitting, when first biometric information is captured by the computer, the first biometric information to the one or more mobile terminal based on the one or more terminal information, specifying, when a collation result of collating between the first biometric information and second biometric information stored in each of the one or more mobile terminal is received from the one or more mobile terminal, a mobile terminal of which the received collation result satisfies a criterion among the one or more mobile terminal, and transmitting settlement information to the specified mobile terminal.

### CROSS-REFERENCE TO RELATED APPLICATION

This application is based upon and claims the benefit of priority of the prior Japanese Patent Application No. 2020-65123, filed on Mar. 31, 2020, the entire contents of which are incorporated herein by reference.

### FIELD

The embodiments discussed herein are related to an information processing method, an information processing system, and an information processing apparatus.

### BACKGROUND

In the related art, as a biometric authentication method for a large number of users, for example, there is a 1:N authentication method. For example, in the 1:N authentication method, a server holds a large amount of biometric information of users in advance, collates the biometric information of a user to be authenticated is sequentially with the held biometric information, and performs identity authentication on the user to be authenticated based on an authentication result. As a result, for example, the identity of the user may be authenticated at the time of settlement to purchase a commodity in a shop or the like,

An example of related art is described in Japanese Laid-open Patent Publication No. 2016-062132.

### SUMMARY

According to an aspect of the embodiments, an information processing method that causes a computer to execute a process, the process includes receiving one or more terminal information transmitted from one or more mobile terminal whose position with respect to the computer satisfy a condition, transmitting, when first biometric information is captured by the computer, the first biometric information to the one or more mobile terminal based on the one or more terminal information, specifying, when a collation result of collating between the first biometric information and second biometric information stored in each of the one or more mobile terminal is received from the one or more mobile terminal, a mobile terminal of which the received collation result satisfies a criterion among the one or more mobile terminal, and transmitting settlement information to the specified mobile terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a settlement system of the present embodiment;

FIG. 2 is an explanatory diagram illustrating an example of an arrangement relationship in the settlement system in a shop;

FIG. 3 is a block diagram illustrating an example o hardware configuration of a smartphone terminal;

FIG. 4 is a block diagram illustrating an example of a functional configuration of the smartphone terminal;

FIG. 5 is a block diagram illustrating an example of a hardware configuration of a settlement terminal;

FIG. 6 is a block diagram illustrating an example of a functional configuration of the settlement terminal;

FIG. 7 is a sequence diagram illustrating an example of processing operation of the settlement system;

FIGS. 8A and 8B are flowcharts illustrating an example of processing operation of the smartphone terminal related to a smartphone-side settlement process;

FIGS. 9A and 9B are flowcharts illustrating an example of processing operation of the settlement terminal related to a settlement authentication process; and

FIG. 10 is a block diagram illustrating an example of a computer that executes an information processing program.

### DESCRIPTION OF EMBODIMENTS

In the 1:N authentication method, in a case where the number N of pieces of biometric information held by the server increases, the biometric information of the user to be authenticated is sequentially collated with all the pieces of biometric information held by the server, so that a processing load on the server side due to collation increases. In the case where the processing load on the server side due to the collation increases, it takes time for the collation.

Hereinafter, embodiments of a technology capable of reducing a processing load due to identity authentication at the time of settlement will be described in detail with reference to the drawings. The embodiments are not intended to limit the disclosed technology. The embodiments below may be combined appropriately within a range not causing any contradiction.

### Embodiments

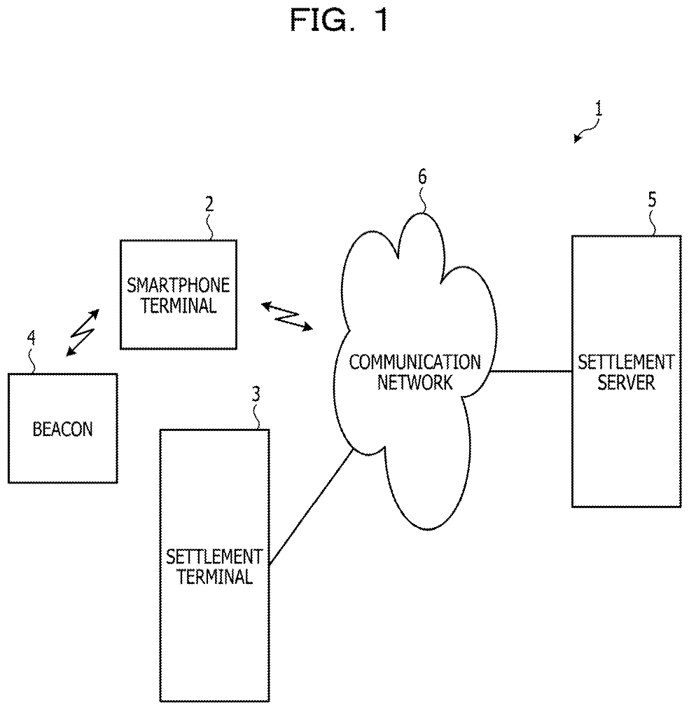

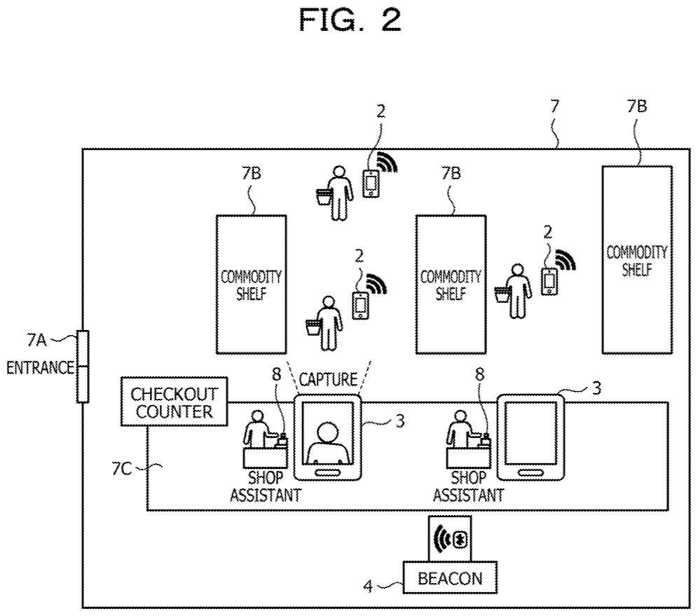

FIG. 1 is an explanatory diagram illustrating an example of a settlement system 1 of the present embodiment. The settlement system 1 illustrated in FIG. 1 includes a smartphone terminal 2, a settlement terminal 3, a beacon 4, a settlement server 5, and a communication network 6. The smartphone terminal 2 is, for example, a mobile terminal carried by a user who purchases a commodity in a shop 7 (see FIG. 2). For example, a tablet terminal or the like may be used instead of the smartphone terminal 2. The settlement terminal 3 is, for example, an information processing apparatus used by a shop assistant at a checkout counter 7C (see FIG. 2) in the shop 7. The settlement terminal 3 is, for example, an information processing apparatus such as a personal computer, a tablet terminal, or a smartphone terminal.

The beacon 4 is a transmission device that distributes service coupling information to the smartphone terminal 2 around the checkout counter 7C in the shop 7 by, for example, a short-distance wireless communication method such as Bluetooth (registered trademark) low energy (BLE). The beacon 4 periodically performs polling communication to establish a session with the smartphone terminal 2 existing in the communication range, establishes the session in a case where the smartphone terminal 2 that has received the polling appears, and transmits service coupling information to the smartphone terminal 2. The service coupling information is coupling information of the settlement terminal 3 that provides a settlement service within an automatically authenticatable range, for example, coupling information indicating a coupling ID that enables communication with the settlement terminal 3. The automatically authenticatable range is an area for providing the settlement service in which the settlement terminal 3 automatically performs identity authentication when the user carrying the smartphone terminal 2 performs settlement on a commodity to be purchased, and proceeds the settlement after performing the identity authentication. By reducing the area that is the automatically authenticatable range, biometric information may be transmitted to all the smartphone terminals 2 existing within the automatically authenticatable range simultaneously and in a short time.

The beacon 4 transmits at all times the service coupling information within a short-distance wireless communication range around the checkout counter 7C. Therefore, in a case where the user carrying the smartphone terminal 2 has entered the short-distance wireless communication range of the beacon 4, the smartphone terminal 2 receives the service coupling information from the beacon 4. Ina case of receiving the service coupling information from the beacon 4, the smartphone terminal 2 recognizes that the smartphone terminal 2 itself exists within the automatically authenticatable range.

The settlement server 5 is, for example, an information processing apparatus such as a server device that executes a settlement process in a settlement service agency. The settlement service agency is an agency that performs settlement on a commodity on behalf of the user. The communication network 6 is, for example, a communication network such as an internet or a local area network (LAN). For convenience of explanation, in the settlement system 1 illustrated in FIG. 1, one smartphone terminal 2, one settlement terminal 3, and one beacon 4 are exemplified. However, the number of smartphone terminals 2, the number of settlement terminals 3, and the number of beacons 4 are not limited to one, may be plural, and may be changed as appropriate.

FIG. 2 is an explanatory diagram illustrating an example of an arrangement relationship in the settlement system 1 in the shop 7. The shop 7 illustrated in FIG. 2 includes an entrance 7A, a plurality of commodity shelves 75, and the checkout counter 7C. The entrance 7A is an entrance of the shop 7. The commodity shelves 7B are shelves where commodities are placed. The checkout counter 7C is a space in which the user presents a commodity to be purchased to the shop assistant, and settlement is performed on the commodity to be purchased, The checkout counter 7C includes a plurality of the settlement terminals 3, the beacon 4, and a point of sale (POS) terminal 8. The settlement terminal 3 is arranged in the communication range of the beacon 4 and in the automatically authenticatable range. The communication range is, for example, 10 m or less, but is not limited to 10 m or less, and may be changed as appropriate. The POS terminal 8 is arranged in the checkout counter 7C, enables communication with the settlement terminal 3, receives information of the commodity to be purchased by bar code reading, calculates a settlement amount of the commodity to be purchased based on information of the commodity to be purchased, and transmits the settlement amount to the settlement terminal 3, In a case of receiving a receipt issue instruction from the settlement terminal 3, the POS terminal 8 issues a receipt of the commodity to be purchased.

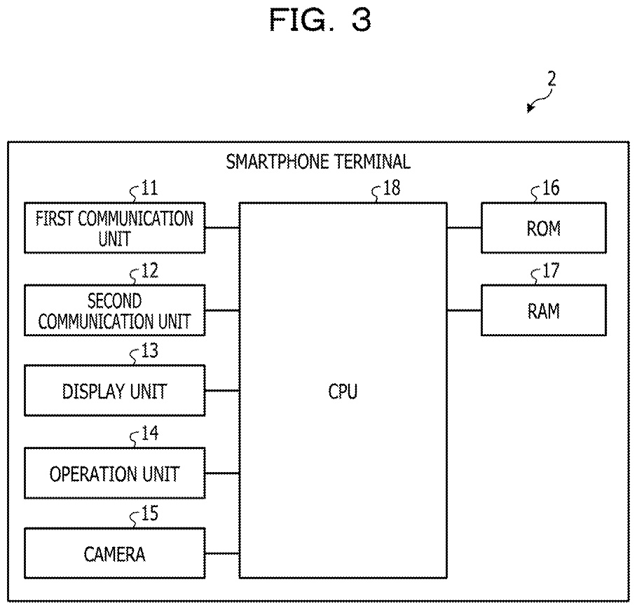

FIG. 3 is a block diagram illustrating an example of a hardware configuration of the smartphone terminal 2. The smartphone terminal 2 illustrated in FIG. 3 includes a first communication unit 11, a second communication unit 12, a display unit 13, an operation unit 14, a camera 15, a read-only memory (ROM) 16, a random-access memory (RAM) 17, and a central processing unit (CPU) 18. The first communication unit 11 is, for example, a communication interface that controls wireless communication such as 4-generation (4G), long term evolution (LTE), or 5G. The second communication unit 12 is, for example, a communication interface that controls short-distance wireless communication such as BLE. The display unit 13 is an output interface for displaying various kinds of information. The operation unit 14 is an input interface for inputting various kinds of information. The camera 15 is an input interface that captures an image of an object, for example, a face image of a user.

The ROM 16 is an area in which various kinds of programs and the like are stored. The RAM 17 is an area in which various kinds of information are stored. The CPU 18 controls the entire smartphone terminal 2. The CPU 18 loads programs stored in the ROM 16 into a work area on the RAM 17 and executes the programs on the RAM 17 as process functions.

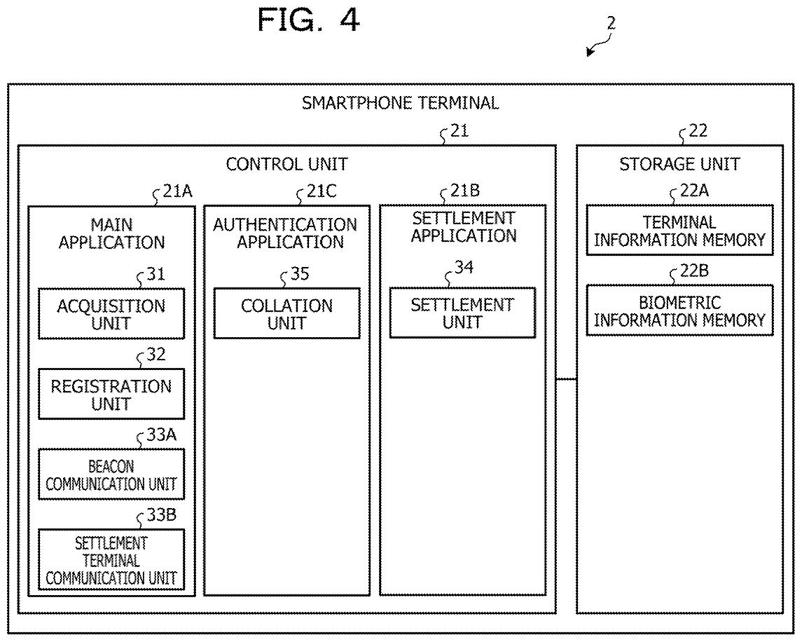

FIG. 4 is a block diagram illustrating an example of a functional configuration of the smartphone terminal 2. The smartphone terminal 2 illustrated in FIG. 4 includes a control unit 21 and a storage unit 22 as process functions. The control unit 21 executes a main application 21A, a settlement application 21B, and an authentication application 21C. The main application 21A is an application for executing various processes of the smartphone terminal 2. The main application 21A includes an acquisition unit 31, a registration unit 32, a beacon communication unit 33A, and a settlement terminal communication unit 33B as functions. The settlement application 21B is an application used at the time of settlement by the smartphone terminal 2. The settlement application 21B includes a settlement unit 34 as a function. The authentication application 21C is an application used for identity authentication at the time of settlement. The authentication application 21C includes a collation unit 35 as a function.

The storage unit 22 includes a terminal information memory 22A and a biometric information memory 22B. The terminal information memory 22A stores terminal information such as a terminal ID for identifying the smartphone terminal 2. The biometric information memory 22B stores registered biometric information of the user of the smartphone terminal 2, which is used for collation, for example, a feature quantity of the face image. The biometric information of the user stored in the biometric information memory 22B is biometric information used for identity authentication of the user. The biometric information of the user stored in the biometric information memory 22B is determined by who permits the service used by the user. For example, in a case where the user uses a service to settle the payment for a commodity to be purchased, the biometric information is biometric information of the user himself or herself who permits the use of the service.

The beacon communication unit 33A communicates with the beacon 4. The settlement terminal communication unit 33B communicates with the settlement terminal 3. In a case of receiving the service coupling information from the beacon 4 through the beacon communication unit 33A, for example, in a case where a position with respect to the settlement terminal 3 satisfies a condition, for example, in a case where the smartphone terminal 2 exists within the automatically authenticatable range, the acquisition unit 31 acquires the terminal ID stored in the terminal information memory 22A. The settlement terminal communication unit 33B transmits the acquired terminal ID to the settlement terminal 3 through the second communication unit 12. For example, only the smartphone terminal 2 that exists within the automatically authenticatable range transmits the terminal ID to the settlement terminal 3.

For example, the registration unit 32 registers biometric information such as a face image of the user captured by the camera 15 in the biometric information memory 22B. In a case of receiving the biometric information from the settlement terminal 3, the collation unit 35 collates the biometric information stored in the biometric information memory 22B with the biometric information received from the settlement terminal 3. The settlement terminal communication unit 33B transmits a collation result to the settlement terminal 3. The collation result is a result of collation between the received biometric information and the stored biometric information. The collation result includes an authentication result OK in which the identity authentication is determined to be successful in a case where the received biometric information matches the stored biometric information, and an authentication result NG in which the identity authentication is determined as failed in a case where the received biometric information does not match the stored biometric information.

In a case of receiving settlement information from the settlement terminal 3, the settlement unit 34 generates settlement data based on a settlement amount of the commodity to be purchased and shop information from the settlement information. The settlement information includes the settlement amount of the commodity to be purchased and the shop information. The settlement unit 34 transmits the generated settlement data to the settlement server 5 via the communication network 6. The settlement data includes the settlement amount of the commodity to be purchased, the shop information, the user ID of the user, and the like.

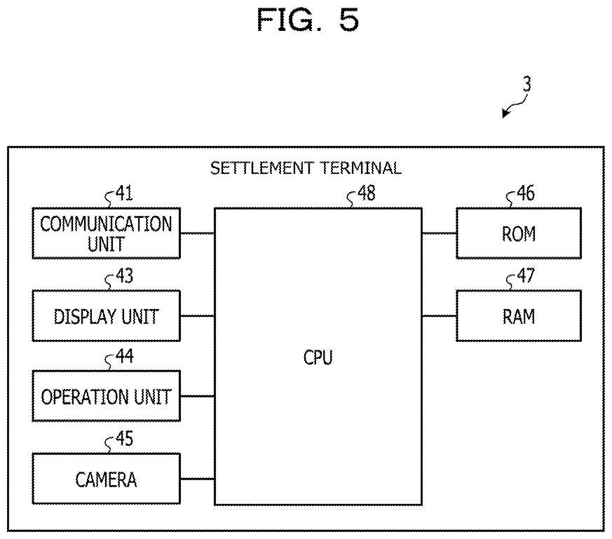

FIG. 5 is a block diagram illustrating an example of a hardware configuration of the settlement terminal 3. The settlement terminal 3 illustrated in FIG. 5 includes a communication unit 41, a display unit 43, an operation unit 44, a camera 45, a ROM 46, a RAM 47, and a CPU 48. The communication unit 41 is a communication interface that performs wired or wireless communication with the communication network 6. The display unit 43 is an output interface for displaying various kinds of information. The operation unit 44 is an input interface for inputting various kinds of information. The camera 45 is an input interface that captures an image of an object, for example, a face image of a user.

The ROM 46 is an area in which various kinds of programs and the like are stored. The RAM 47 is an area in which various kinds of information are stored. The CPU 48 controls the entire settlement terminal 3. It is assumed that a program for realizing processing in the smartphone terminal 2 is stored in, for example, the ROM 46 or the like. The CPU 48 loads programs stored in the ROM 46 into the RAM 47 and executes process functions corresponding to the various kind of programs on the RAM 47.

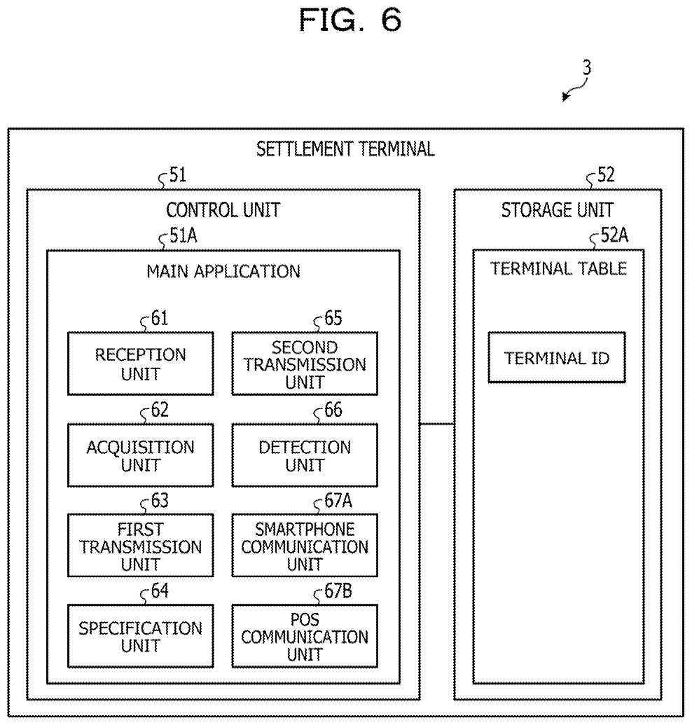

FIG. 6 is a block diagram illustrating an example of a functional configuration of the settlement terminal 3. The settlement terminal 3 illustrated in FIG. 6 includes a control unit 51 and a storage unit 52 as process functions. The control unit 51 executes a main application 51A. The main application 51A is an application cooperating with the POS terminal 8 that manages commodities in the shop 7. The main application 51A includes a reception unit 61, an acquisition unit 62, a first transmission unit 63, a specification unit 64, a second transmission unit 65, a detection unit 66, a smartphone communication unit 67A, and a POS communication unit 67B, as functions.

The smartphone communication unit 67A communicates with the smartphone terminal 2. The POS communication unit 67B communicates with the POS terminal 8. In a case where the terminal ID is received from the smartphone terminal 2 that has entered the automatically authenticatable range through the smartphone communication unit 67A, the reception unit 61 registers the terminal ID of the smartphone terminal 2 in a terminal table 52A. The settlement terminal 3 registers only the terminal ID of the smartphone terminal 2 that exists within the automatically authenticatable range in the terminal table 52A. The POS communication unit 67B receives a settlement notification including the settlement amount of the commodity to be purchased by the user from the POS terminal 8. The acquisition unit 62 acquires the settlement amount from the settlement notification, and generates settlement information including the settlement amount of the commodity to be purchased. The settlement information includes the settlement amount of the commodity to be purchased and the shop information.

In a case where the biometric information detected by the detection unit 66 is accepted, the first transmission unit 63 transmits the accepted biometric information to each smartphone terminal 2 through the smartphone communication unit 67A based on the terminal ID stored in the terminal table 52A, The specification unit 64 receives the authentication result from each smartphone terminal 2 through the smartphone communication unit 67A, and specifies the smartphone terminal 2 of which the received authentication result satisfies a criterion. The specification unit 64 specifies the terminal ID of the smartphone terminal 2 of which the authentication result satisfies the criterion, for example, the terminal ID of the smartphone terminal 2 with the authentication result OK. The second transmission unit 65 transmits the settlement information to the specified smartphone terminal 2 through the smartphone communication unit 67A.

The detection unit 66 captures a face image of a commodity purchaser to be authenticated by the camera 45, and detects biometric information such as the captured face image of the commodity purchaser to be authenticated.

The settlement terminal 3 registers, in the terminal table 52A, only the terminal ID of the smartphone terminal 2 that has entered the automatically authenticatable range in the vicinity of the checkout counter 7C. In a case where a plurality of persons exist within the automatically authenticatable range, the terminal IDs are transferred from the smartphone terminals 2 carried by all the persons to the settlement terminal 3. As a result, it means that a population to be authenticated is created based on the relative positional relationship (the automatically authenticatable range) or the distance (the range where an electric wave of the beacon 4 reaches in the present case) between the location (the checkout counter 7C in the present case) where the service is provided and the user (information on target persons who may be authenticated is collected in advance on the spot).

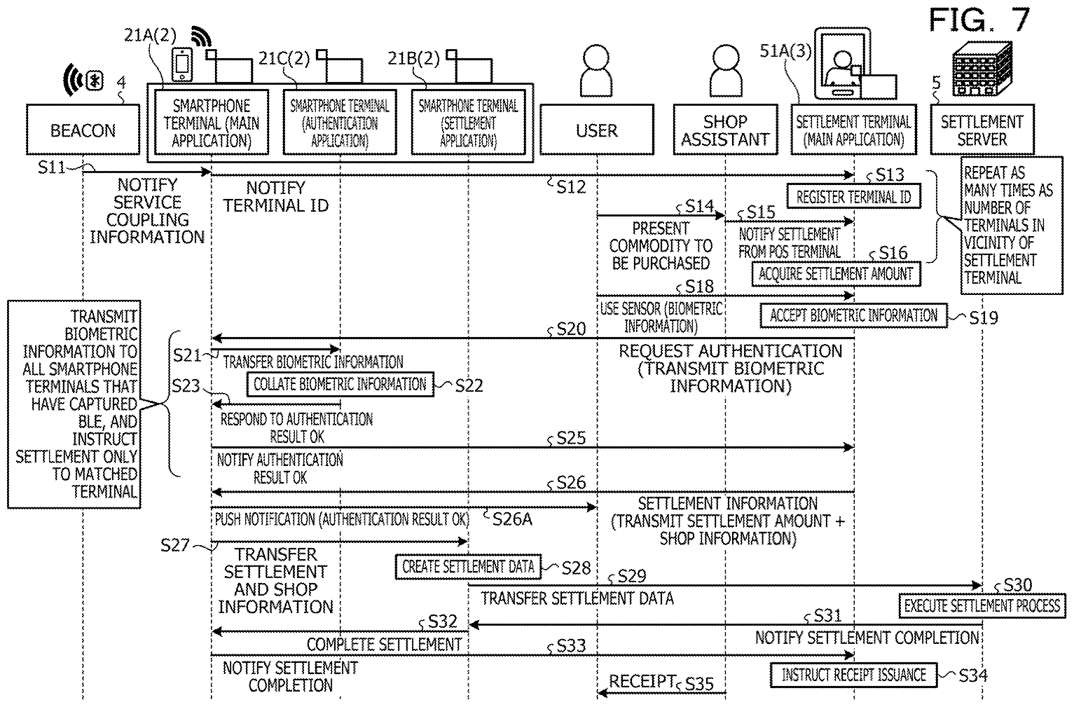

FIG. 7 is a sequence diagram illustrating an example of processing operation of the settlement system 1. For example, it is assumed that the user carrying the smartphone terminal 2 enters the shop 7 to purchase a commodity, takes the commodity, and approaches the checkout counter 7C. It is assumed that the user acquires his or her biometric information with the camera 15 in the smartphone terminal 2 and registers the acquired biometric information in the biometric information memory 22B in advance.

In a case of receiving the service coupling information from the beacon 4 through the second communication unit 12 (operation S11), the beacon communication unit 33A in the main application 21A of the smartphone terminal 2 illustrated in FIG. 7 reads the terminal ID stored in the terminal information memory 22A and the biometric information stored in the biometric information memory 22B. The settlement terminal communication unit 33B in the main application 21A transmits the read terminal ID to the settlement terminal 3 (operation S12).

In a case of receiving the terminal ID, the main application 51A in the settlement terminal 3 registers the terminal ID in the terminal table 52A (operation S13). The settlement terminal 3 registers only the terminal ID of the smartphone terminal 2 that exists within the automatically authenticatable range in the terminal table 52A.

In a case where the user presents the commodity to be purchased (operation S14), the shop assistant at the checkout counter 7C reads the commodity to be purchased by the POS terminal 8, calculates the total amount of the commodity to be purchased, gets a confirmation on a settlement method of the commodity to be purchased from the user, and transmits a settlement notification including the settlement amount to the settlement terminal 3 through the POS terminal 8 in a case where biometric authentication is used as the settlement method (operation S15). An operation for selecting the settlement method includes, for example, a button operation of the POS terminal 8 for selecting settlement by biometric authentication, settlement by QR code (registered trademark), settlement by credit card, or cash settlement. The main application 51A in the settlement terminal 3 acquires the settlement amount of the commodity to be purchased from the settlement notification from the POS terminal 8 (operation S16). In a case where the settlement amount of the commodity to be purchased is acquired, the camera 45 of the settlement terminal 3 acquires the biometric information of the user who is the commodity purchaser (operation S18). The main application 51A of the settlement terminal 3 accepts the acquired biometric information of the user (operation S19).

The smartphone communication unit 67A in the main application 51A transmits an authentication request including the biometric information accepted at operation S19 to each smartphone terminal 2 based on the terminal ID that has been registered in the terminal table 52A (operation S20). The settlement terminal 3 transmits the authentication request to each smartphone terminal 2 within the automatically authenticatable range based on the terminal ID that has been registered in the terminal table 52A. In a case of receiving the authentication request, the main application 21A of each smartphone terminal 2 transfers the biometric information in the authentication request to the authentication application 21C (operation S21). The authentication application 21C collates the transferred biometric information with the biometric information that has been registered in the biometric information memory 22B (operation S22).

In a case where the authentication result is OK, the authentication application 21C transmits the authentication result OK to the main application 21A (operation S23). The settlement terminal communication unit 33B in the main application 21A transmits the authentication result OK to the settlement terminal 3 through the second communication unit 12 (operation S25). The settlement terminal 3 receives the authentication result from each smartphone terminal 2 within the automatically authenticatable range, and specifies the smartphone terminal 2 of which the received authentication result satisfies the criterion, for example, the smartphone terminal 2 with the authentication result OK.

In a case of receiving the authentication result OK, the main application 51A in the settlement terminal 3 generates settlement information including the settlement amount of the commodity to be purchased, the items of the commodity to be purchased, and the shop information, and transmits the settlement information to the smartphone terminal 2 through the smartphone communication unit 67A (operation S26). The smartphone terminal 2 notifies the user of the authentication result OK by sound, vibration, or the like in response to the receipt of the settlement information (operation S26A). The user of the smartphone terminal 2 may recognize that the authentication result is OK, for example, the identity authentication used for settlement of the commodity to be purchased is successful, by sound, vibration, or the like.

In a case of receiving the settlement information from the settlement terminal 3 through the settlement terminal communication unit 33B, the main application 21A of the smartphone terminal 2 transfers the settlement amount of the commodity to be purchased and the shop information in the settlement information to the settlement application 21B in the smartphone terminal 2 (operation S27). The settlement application 21B generates settlement data including the settlement amount of the commodity to be purchased, the shop information, and the user ID in the settlement information (operation S28). The settlement application 21B transmits the settlement data to the settlement server 5 of the settlement service agency through the first communication unit 11 (operation S29).

In a case of receiving the settlement data from the smartphone terminal 2, the settlement server 5 of the settlement service agency executes a settlement process of settling the settlement amount of the commodity to be purchased in the settlement data (operation S30), and transmits a settlement completion notification to the smartphone terminal 2 (operation S31).

In a case of receiving the settlement completion notification, the settlement application 21B of the smartphone terminal 2 notifies the main application 21A of the settlement completion (operation S32). In a case of receiving the settlement completion, the settlement terminal communication unit 33B in the main application 21A of the smartphone terminal 2 transmits the settlement completion notification to the settlement terminal 3 through the second communication unit 12 (operation S33). In a case of receiving the settlement completion notification of the purchased commodity, the POS communication unit 67B in the settlement terminal 3 transmits an instruction to issue a receipt for the settlement completion of the purchased commodity to the POS terminal 8 (operation S34). The POS terminal 8 prints out the receipt in response to the instruction to issue the receipt. The shop assistant gives the user the receipt printed out by the POS terminal 8 (operation S35), so that the purchase of the commodity is completed. As a result, the user may visually recognize the contents of the receipt to recognize that the settlement of the purchased commodity is completed. Although the case where the settlement server 5 transmits the settlement completion notification to the smartphone terminal 2 after executing the settlement process at operation S30 is exemplified, the settlement completion notification may be transmitted to the settlement terminal 3. In this case, the settlement terminal 3 may provide the receipt to the user in response to the settlement completion notification from the settlement server 5, and may be changed as appropriate.

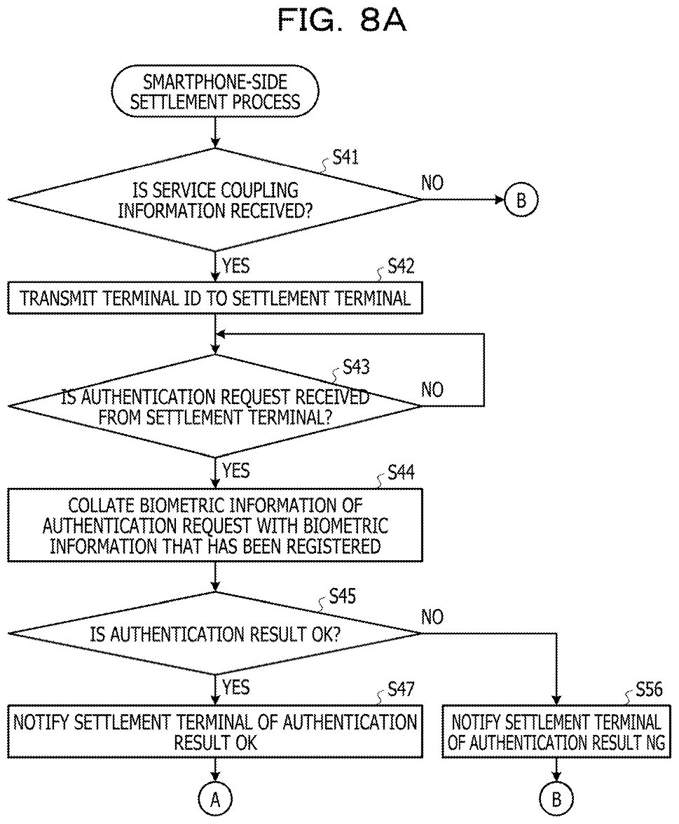

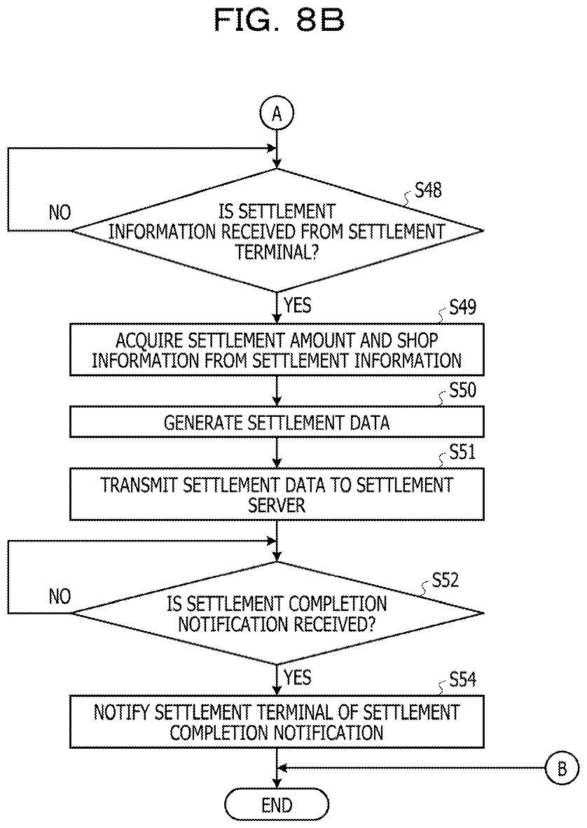

FIG. 8 is a flowchart illustrating an example of processing operation of the smartphone terminal 2 related to a smartphone-side settlement process. In FIG. 8, the beacon communication unit 33A in the smartphone terminal 2 determines whether or not the service coupling information is received from the beacon 4 (operation S41). In a case of receiving the service coupling information from the beacon 4 (Yes at operation S41), the acquisition unit 31 transmits the terminal ID stored in the terminal information memory 22A to the settlement terminal 3 through the settlement terminal communication unit 33B based on the coupling ID in the service coupling information (operation S42). The settlement terminal communication unit 33B in the smartphone terminal 2 determines whether or not the authentication request is received from the settlement terminal 3 (operation S43). The authentication request includes biometric information.

In a case of receiving the authentication request (Yes at operation S43), the collation unit 35 collates the biometric information in the authentication request with the biometric information that has been registered (operation S44). The collation unit 35 determines whether or not the authentication result is OK (operation S45). In a case where the authentication result is OK (Yes at operation S45), the collation unit 35 transmits the authentication result OK to the settlement terminal 3 through the settlement terminal communication unit 33B (operation S47). The settlement terminal communication unit 33B in the smartphone terminal 2 determines whether or not the settlement information is received from the settlement terminal 3 (operation S48). In a case of receiving the settlement information (Yes at operation S48), the settlement unit 34 acquires the settlement amount of the commodity to be purchased, the shop information, and the like from the settlement information (operation S49).

The settlement unit 34 generates settlement data including the settlement amount of the commodity to be purchased, the shop information, the user ID, and the like (operation S50), and transmits the settlement data to the settlement server 5 of the settlement service agency (operation S51). The settlement server 5 executes the settlement of payment to purchase the commodity on behalf of the user based on the settlement data. The settlement unit 34 determines whether or not the settlement completion notification is received from the settlement server 5 (operation S52).

In a case of receiving the settlement completion notification through the settlement terminal communication unit 33B (Yes at operation S52), the settlement unit 34 notifies the settlement terminal 3 of the settlement completion notification (operation S54), and ends the processing operation illustrated in FIG. 8. The settlement completion notification is a notification indicating that the settlement is normally completed. However, in a case where the settlement completion notification is, for example, a settlement NG notification indicating that the settlement may not be normally performed, the settlement unit 34 may proceed to operation S54 to notify the settlement terminal 3 of the settlement. NG, which may be changed as appropriate.

In a case of not receiving the service coupling information (No at operation S41), the smartphone terminal 2 ends the processing operation illustrated in FIG. 8. In a case of not receiving the authentication request from the settlement terminal 3 (No at operation S43), the settlement terminal communication unit 33B proceeds to operation S43 to determine whether or not the authentication request is received. In a case where the authentication result is not OK (No at operation S45), the collation unit 35 transmits the authentication result NG to the settlement terminal 3 through the settlement terminal communication unit 33B (operation S56), and ends the processing operation illustrated in FIG. 8.

In a case of not receiving the settlement information from the settlement terminal 3 (No at operation S48), the settlement terminal communication unit 33B proceeds to operation S48 to determine whether or not the settlement information is received. In a case of not receiving the settlement completion notification from the settlement server 5 (No at operation S52), the settlement unit 34 proceeds to operation S52 to determine whether or not the settlement completion notification is received.

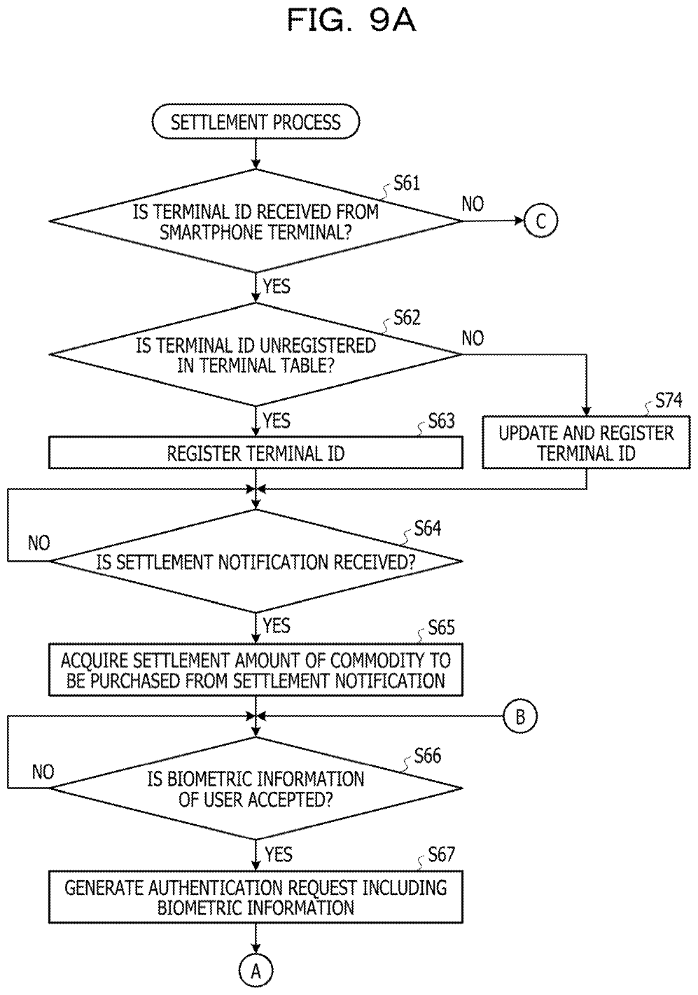

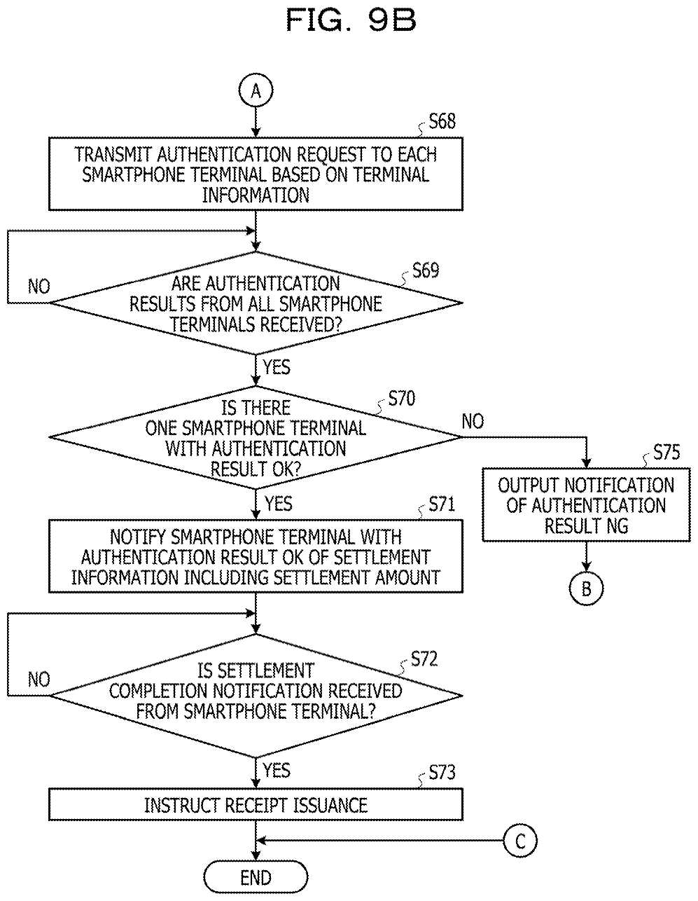

FIG. 9 is a flowchart illustrating an example of processing operation of the settlement terminal 3 related to a settlement authentication process. In FIG. 9, the reception unit 61 in the settlement terminal 3 determines whether or not the terminal ID is received from the smartphone terminal 2 through the smartphone communication unit 67A (operation S61). In a case of receiving the terminal ID (Yes at operation S61), the reception unit 61 determines whether or not the terminal ID is unregistered in the terminal table 52A (operation S62).

In a case where the terminal ID is unregistered (Yes at operation S62), the reception unit 61 registers the terminal ID received at operation S61 in the terminal table 52A (operation S63). For example, the settlement terminal 3 pre-registers only the terminal ID of the smartphone terminal 2 existing within the automatically authenticatable range.

The POS communication unit 67B in the settlement terminal 3 determines whether or not the settlement notification is received from the POS terminal 8 (operation S64). In a case of receiving the settlement notification from the POS terminal 8 (Yes at operation S64), the acquisition unit 62 in the settlement terminal 3 acquires the settlement amount of the commodity to be purchased from the settlement notification (operation S65). In a case of acquiring the settlement amount of the commodity to be purchased from the POS terminal 8, the detection unit 66 in the settlement terminal 3 determines whether or not the biometric information of the user who is the commodity purchaser is accepted through the camera 45 (operation S66).

In a case of accepting the biometric information of the user (Yes at operation S66), the first transmission unit 63 in the settlement terminal 3 generates an authentication request including the accepted biometric information (operation S67). The first transmission unit 63 transmits the authentication request to each smartphone terminal 2 through the smartphone communication unit 67A based on the terminal ID that has been registered in the terminal table 52A (operation S68). The specification unit 64 in the settlement terminal 3 determines whether or not the authentication results from all the smartphone terminals 2 to which the authentication request has been transmitted are received through the smartphone communication unit 67A (operation S69). In a case of receiving the authentication results from all the smartphone terminals 2 (Yes at operation S69), the specification unit 64 determines whether or not the number of the smartphone terminals 2 with the authentication result OK is one (operation S70).

In a case where there is one smartphone terminal 2 with the authentication result OK (Yes at operation S70), the second transmission unit 65 in the settlement terminal 3 transmits settlement information to the smartphone terminal 2 with the authentication result OK through the smartphone communication unit 67A based on the terminal ID (operation S71). The settlement information includes, for example, the settlement amount of the commodity to be purchased, and the shop information. The smartphone terminal 2 with the authentication result OK is the smartphone terminal 2 that satisfies the criterion.

The main application 51A in the settlement terminal 3 determines whether or not the settlement completion notification is received from the smartphone terminal 2 (operation S72). In a case of receiving the settlement completion notification (Yes at operation S72), the POS communication unit 67B in the main application 51A transmit the receipt issue instruction for printing out the receipt of the purchased commodity to the POS terminal 8 (operation S73), and ends the processing operation illustrated in FIG. 9.

In a case of not receiving the terminal ID from the smartphone terminal 2 (No at operation S61), the reception unit 61 ends the processing operation illustrated in FIG. 9. In a case where the terminal ID is not unregistered in the terminal table 52A (No at operation S62), for example, in a case where the terminal ID has been registered, the reception unit 61 updates and registers the terminal ID in the terminal table 52A (operation S74). The process proceeds to operation S64 to determine whether or not the settlement notification is received. In a case of not receiving the settlement notification (No at operation S64), the settlement terminal 3 proceeds to operation S64 to determine whether or not the settlement notification is received. In a case where the biometric information of the user is not accepted (No at operation S66), the detection unit 66 proceeds to operation S66 to determine whether the biometric information of the user is accepted.

In a case of not receiving the authentication results from all the smartphone terminals 2 through the smartphone communication unit 67A (No at operation S69), the specification unit 64 proceeds to operation S69 to determine whether or not the authentication results from all the smartphone terminals 2 are received. In a case where there are two or more smartphone terminals 2 with the authentication result OK (No at operation S70), the specification unit 64 outputs a notification indicating that the authentication result is NG to the shop assistant (operation S75), and proceeds to operation S66 to determine whether or not the biometric information of the user is accepted. The shop assistant recognizes failure of the identity authentication of the commodity purchaser in response to the notification output of the authentication result NG. For example, the shop assistant urges the commodity purchaser to perform the operation of acquiring the biometric information again.

In a case of not receiving the settlement completion notification from the smartphone terminal 2 (No at operation S72), the main application 51A proceeds to operation S72 to determine whether or not the settlement completion notification is received.

The settlement terminal 3 of the present embodiment receives the plurality of terminal IDs that are respectively transmitted from the plurality of smartphone terminals 2 whose positions with respect to the settlement terminal 3 satisfy the condition. In a case where the detected biometric information is accepted, the settlement terminal 3 transmits the accepted biometric information to each smartphone terminal 2 based on the plurality of terminal IDs. In a case where the collation result between the biometric information stored in each of the plurality of the smartphone terminals 2 and the transmitted biometric information is received from each smartphone terminal 2, the settlement terminal 3 specifies the smartphone terminal 2 of which the received collation result satisfies the criterion among the plurality of smartphone terminals 2. The settlement terminal 3 transmits the settlement. information to the specified smartphone terminal 2. As a result, the processing load due to identity authentication at the time of settlement may be reduced.

In the present embodiment, among an unspecified large number of users, the commodity purchaser of the smartphone terminal 2 that exists in the communication range of the beacon 4, for example, the automatically authenticatable range around the settlement terminal 3 is subjected to authentication, so that the number of pieces of biometric information belonging to the population to be authenticated may be largely limited. For example, the settlement terminal 3 registers the terminal ID of the smartphone terminal 2 existing in the automatically authenticatable range, and transmits the biometric information of the commodity purchaser to each smartphone terminal 2 based on the terminal ID. Each smartphone terminal 2 collates the received biometric information with its own biometric information, and transmits the authentication result to the settlement terminal 3. The settlement terminal 3 transmits the settlement information to the smartphone terminal 2 with the authentication result OK among the authentication results received from the respective smartphone terminals 2. For example, each smartphone terminal 2 bears the process used for its own authentication and management. As a result, a processing load due to authentication and management may be significantly reduced.

In the present embodiment, since the 1:1 authentication method is used, it is possible to use a cheaper biometric authentication engine (it is possible to lower cost). In the present embodiment, since the smartphone terminal 2 has only to be specified when the user to be authenticated enters the automatically authenticatable range, it is possible to complete advance preparation instantly (service preparation time is short). Since the biometric information is not stored in the settlement terminal 3, a security level is high. In the present embodiment, the implementation may be achieved at low cost (to suppress the cost of service provision or management per one ID), and an upper limit constraint on the number of pieces registered data may be substantially removed.

In a 1:N authentication method in the related art, a database that centrally manages a large amount of biometric information is provided. In a case where the number of pieces of biometric information held in the database is more than a certain number of populations, a processing load during the collation with biometric information of the user to be authenticated increases. On the other hand, the settlement terminal 3 of the present embodiment acquires the terminal ID of the smartphone terminal 2 of the user who has entered the automatically authenticatable range in the vicinity of the settlement terminal 3, accepts the biometric information of the commodity purchaser, and transmits the accepted biometric information to each smartphone terminal 2 based on the terminal ID. Each smartphone terminal 2 collates the accepted biometric information with the biometric information that has been registered, and bears the process for the collation process. As a result, the processing load due to the authentication and management of the settlement terminal 3 may be significantly reduced. Since a large amount of biometric information is not managed by the settlement terminal 3-side, the influence of information leakage may be suppressed to the minimum even in a case where the biometric information leaks from the settlement terminal 3-side, as well as the management burden.

By using the present embodiment for individual specification (member and non-member specification) when a user visits the shop, development to an unmanned shop may be easily realized.

In the settlement system 1 of the above-described embodiment, it is exemplified that the beacon 4 in the vicinity of the settlement terminal 3 periodically transmits the service coupling information, and in the case where the smartphone terminal 2 that has entered the communication range of the beacon 4 receives the service coupling information from the beacon 4, the smartphone terminal 2 transmits the terminal ID to the settlement terminal 3. However, instead of from the beacon 4, in a case of simply receiving the service coupling information, the smartphone terminal 2 may transmit the terminal ID. Although the case where the beacon 4 is arranged in the vicinity of the settlement terminal 3 is exemplified, the settlement terminal 3 itself may periodically transmit the service coupling information instead of the beacon 4, which may be changed as appropriate. The settlement terminal 3 may include the beacon 4.

Although the case where the beacon 4 transmits the service coupling information in the automatically authenticatable range to the smartphone terminal 2 of the user who has entered the communication range of the beacon 4 is exemplified, position information of the shop where the settlement terminal 3 is used or position information for identifying the position of the settlement terminal 3 in the shop may be transmitted, which may be changed as appropriate.

It is exemplified that in the case of receiving the service coupling information from the beacon 4, the smartphone terminal 2 determines that the user exists within the automatically authenticatable range, and transmits the terminal ID to the settlement terminal 3. However, the way in which the smartphone terminal 2 determines that the user exists within the automatically authenticatable range is not limited to reception of the service coupling information from the beacon 4, and the smartphone terminal 2 may be provided with a position specification function capable of identifying that the user exists within the automatically authenticatable range, which may be changed as appropriate. Instead of the beacon 4, the smartphone terminal 2 may be notified of the service coupling information from, for example, a Wi-Fi positioning function, a radio-frequency identification (RFID) positioning function, a Global Positioning System (GPS) positioning function, a pedestrian dead reckoning positioning function, or the like, Instead of the beacon 4, the smartphone terminal 2 may be notified of the service coupling information from, for example, a geomagnetic positioning function, a sound wave positioning function, a visible light positioning function, an indoor messaging system (IMES) positioning function, an ultra-wide band (UWB) positioning function, or the like. Even though the smartphone terminal 2 does not have a positioning function, in a case where the user carrying the smartphone terminal 2 has entered the automatically authenticatable range, the smartphone terminal 2 may transmit the terminal ID to the settlement terminal 3 by an operation of the user, which may be changed as appropriate. Although the mechanism for grasping the position is as described above, a mechanism capable of grasping a position in the vicinity by utilizing this mechanism, for example, a mechanism capable of narrowing down the number of terminals to a plurality of terminals may be constructed, which may be changed as appropriate.

It is exemplified that the beacon 4 transmits the service coupling information including the coupling ID for identifying the settlement terminal 3 to the smartphone terminal 2 that has entered the automatically authenticatable range. However, each information notification server that manages the service coupling information including the coupling ID of the settlement terminal 3 may be separately provided for each beacon ID identifying the beacon 4.

In this case, the beacon 4 transmits the beacon ID instead of the service coupling information to the smartphone terminal 2 that has entered the automatically authenticatable range. The smartphone terminal 2 notifies the information notification server of a search request including the beacon ID. In a case of receiving the search request, the information notification server transmits the service coupling information corresponding to the beacon ID in the search request to the smartphone terminal 2. As a result, the smartphone terminal 2 may transmit the terminal ID to the settlement terminal 3 based on the coupling ID in the service coupling information received from the information notification server.

It is exemplified that the settlement terminal 3 registers the terminal ID received from the smartphone terminal 2 in the terminal table 52A. However, timekeeping by a timer may be started upon registration or update of the terminal ID of the smartphone terminal 2 on the terminal table 52A, and the terminal ID may be deleted from the terminal table 52A after a predetermined time elapses. In this case, a situation in which the terminal ID remains in the settlement terminal 3 may be avoided.

After registering the terminal ID received from the smartphone terminal 2 in the terminal table 52A, in a case where the settlement of the commodity is completed, for example, in a case where the settlement completion notification is received from the smartphone terminal 2, the settlement terminal 3 may delete the terminal ID of the user from the terminal table 52A. In this case, a situation in which the terminal ID remains in the settlement terminal 3 may be avoided.

In a case where the smartphone terminal 2 leaves the automatically authenticatable range, the settlement terminal 3 may delete the terminal ID of the smartphone terminal 2 from the terminal table 52A. In this case, a situation in which the terminal ID remains in the settlement terminal 3 may be avoided.

Although the feature quantity of the face image of the user is exemplified as the biometric information, the biometric information is not limited to the feature quantity of the face image, as long as any biometric information that may authenticate an individual user may be used. For example, biometric information such as a fingerprint, a vein, or an iris of the user may be used. In a case where a fingerprint is used as the biometric information, the smartphone terminal 2 and the settlement terminal 3 include a fingerprint reading unit that reads the fingerprint of the user. In a case where a vein is used as the biometric information, the smartphone terminal 2 and the settlement terminal 3 include a vein reading unit that reads the vein of the user. In a case where an iris is used as the biometric information, the smartphone terminal 2 and the settlement terminal 3 include an iris reading unit that reads the iris of the user. Although the case where the face image of the user is captured by the camera 15 of the smartphone terminal 2 in order to register the biometric information is exemplified, the device used to capture the face image is not limited to the camera 15 of the smartphone terminal 2, and for example, the face image of the user may be captured by another device (biometric data registration device) different from the smartphone terminal 2 or a camera existing on a network, which may be changed as appropriate.

The case where the smartphone terminal 2 transmits the terminal ID to the settlement terminal 3 according to the service coupling information, and the case where the settlement terminal 3 transmits the accepted biometric information to each smartphone terminal 2 are exemplified. However, the terminal ID to be transmitted from the smartphone terminal 2 may be encrypted, and the encrypted terminal ID may be transmitted to the settlement terminal 3. The biometric information to be transmitted from the settlement terminal 3 may be encrypted, and the biometric information that has been encrypted may be transmitted to each smartphone terminal 2. As a result, a security level of the terminal ID transmitted from the smartphone terminal 2 to the settlement terminal 3 and a security level of the biometric information transmitted from the settlement terminal 3 to the smartphone terminal 2 are improved.

In the case of receiving the service coupling information from the beacon 4, the smartphone terminal 2 may generate a one time ID for identifying the smartphone terminal 2, which is used only while existing within an electric wave reception range of the beacon 4, and may transmit the one time ID to the settlement terminal 3 instead of the terminal ID. For example, in a case of receiving the service coupling information of the settlement terminal 3 from the beacon 4, the smartphone terminal 2 transmits the coupling ID of the settlement terminal 3 and its own terminal ID to the server. The server converts the terminal ID received from the smartphone terminal 2 that has made a request to the settlement terminal 3 having the coupling ID into a one time ID effective only for the session, and transmits the one time ID to the settlement terminal 3. The server manages the terminal ID and the one time ID and does not hold the biometric information. In the settlement terminal 3, the smartphone terminal 2 may not be specified from the one time ID. Therefore, since the biometric information does not remain in the server, information constituted by combining the terminal ID with the biometric information exists only in the smartphone terminal 2, and security is maintained.

Although the present embodiment is described as being applied to settlement of a commodity in a shop, the present embodiment is also applicable to, for example, an entrance and exit (reception) sensor, a door, a gate, a locker, a vending machine, and the like.

The constituent elements of the respective units illustrated in the drawings do not necessarily have to be physically configured as illustrated. For example, specific configurations of dispersion and integration of the respective units are not limited to those illustrated in the drawings, and all or some of the elements may be configured in a functionally or physically dispersed and integrated manner in an arbitrary unit depending on various loads, usage, and the like.

All or arbitrary part of various processing functions performed in each apparatus may be implemented by a central processing unit (CPU), a digital signal processor (DSP), a field-programmable gate array (FPGA), or the like. All or arbitrary part of the various processing functions may be implemented by a program analyzed and executed by a CPU or the like, or by hardware of wired logic.

The area that stores various kinds of information may be constituted by, for example, a read-only memory (ROM), or a random-access memory (RAM) such as a synchronous dynamic random-access memory (SDRAM), a magneto-resistive random-access memory (MRAM), or a non-volatile random-access memory (NVRAM).

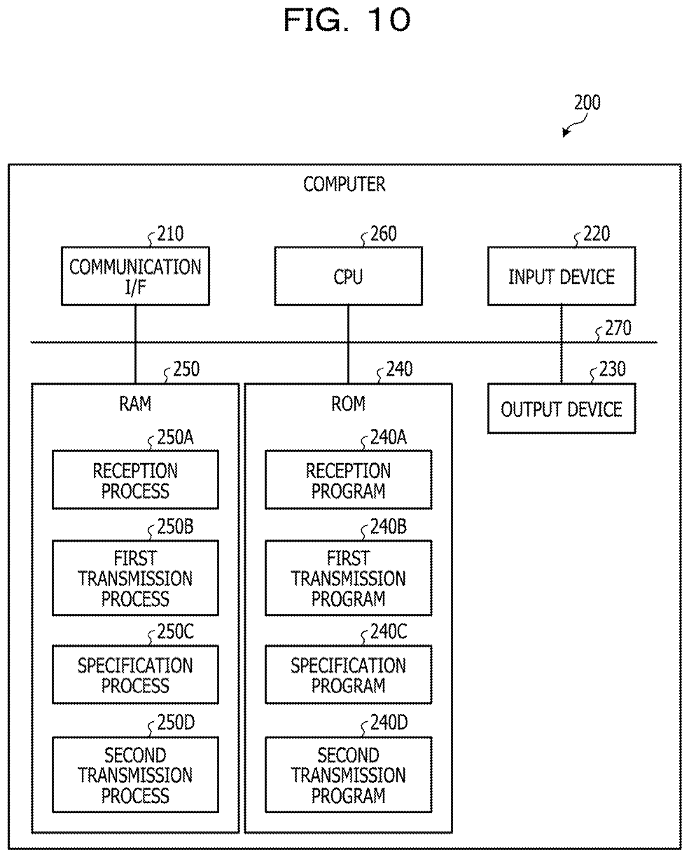

The various processes described in the present embodiment may be implemented by a processor such as a CPU in a computer executing a program prepared in advance. Accordingly, an example of a computer that executes a program having substantially the same functions as those of the above-described embodiment will be described below. FIG. 10 is a block diagram illustrating an example of a computer that executes an information processing program.

A computer 200 that executes the information processing program illustrated in FIG. 10 includes a communication interface (IF) 210, an input device 220, an output device 230, a ROM 240, a RAM 250, and a CPU 260. The communication IF 210, the input device 220, the output device 230, the ROM 240, the RAM 250, and the CPU 260 are coupled to one another via a bus 270. The communication IF 210 is an input and output interface that communicates with a mobile terminal of a user. The computer 200 is, for example, a settlement terminal that requests settlement of a commodity to be purchased by the user. The input device 220 is, for example, a detection unit that detects biometric information.

The ROM 240 has the information processing program previously stored therein to exert the same functions as those in the above embodiments. The ROM 240 stores, as the information processing program, a reception program 240A, a first transmission program 240B, a specification program 240C, and a second transmission program 240D. Instead of the ROM 240, a control program may be recorded on a recording medium that is readable by a computer with a drive (not illustrated). The recording medium may be, for example, a compact disc (CD)-ROM, a digital versatile disc (DVD), a portable recording medium such as a Universal Serial Bus (USB) memory, a semiconductor memory such as a flash memory, or the like.

The CPU 260 reads the reception program 240A from the ROM 240 to function as a reception process 250A on the RAM 250. The CPU 260 reads the first transmission program 240B from the ROM 240 to function as a first transmission process 250B on the RAM 250. The CPU 260 reads the specification program 240C from the ROM 240 to function as a specification process 250C on the RAM 250. The CPU 260 reads the second transmission program 240D from the ROM 240 to function as a second transmission process 250D on the RAM 250.

The CPU 260 receives a plurality of pieces of terminal information that are respectively transmitted from a plurality of mobile terminals whose positions with respect to the computer 200 satisfy a condition. In a case where the biometric information detected by a detection unit is accepted, the CPU 260 transmits the accepted biometric information to the plurality of mobile terminals based on the plurality of pieces of terminal information. In a case where a collation result between the biometric information stored in each of the plurality of mobile terminals and the transmitted biometric information is received from the plurality of mobile terminals, the CPU 260 specifies a mobile terminal of which the received collation result satisfies a criterion among the plurality of mobile terminals. The CPU 260 transmits settlement information to the specified mobile terminal. As a result, the processing load at the time of settlement may be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing method that causes a computer to execute a process, the process comprising:
receiving one or more terminal information transmitted from one or more mobile terminal whose position with respect to the computer satisfy a condition;
transmitting, when first biometric information is captured by the computer, the first biometric information to the one or more mobile terminal based on the one or more terminal information;
specifying, when a collation result of collating between the first biometric information and second biometric information stored in each of the one or more mobile terminal is received from the one or more mobile terminal, a mobile terminal of which the received collation result satisfies a criterion among the one or more mobile terminal; and
transmitting settlement information to the specified mobile terminal.

2. The information processing method according to claim 1, the process further comprising:
storing the one or more terminal information in a memory; and
deleting, when a predetermined time has elapsed after first terminal information of the one or more terminal information is stored in the memory, the first terminal information from the memory.

3. The information processing method according to claim 1, the process further comprising:
storing the one or more terminal information in a memory; and
deleting, when a processing completion of the settlement information of the specified mobile terminal is detected, the terminal information corresponding to the specified mobile terminal from the memory.

4. The information processing method according to claim 1, the process further comprising:
storing the one or more terminal information in a memory; and
deleting, when a first mobile terminal of the one or more mobile terminal does not satisfy the condition, the terminal information corresponding to the first mobile terminal from the memory.

5. An information processing system comprising:
a mobile terminal configured to store first biometric information in a memory;
a settlement terminal configured to communicate with the mobile terminal; and
a beacon configured to transmit, to the mobile terminal, service coupling information of the settlement terminal within a transmission range of the settlement terminal,
wherein the mobile terminal transmits, when the service coupling information from the beacon is received, terminal information for identifying the mobile terminal to the settlement terminal,
wherein the settlement terminal:
receives the terminal information from the mobile terminal, and
transmits, when second biometric information is captured by the settlement terminal, the second biometric information to mobile terminal based on the terminal information,
wherein the mobile terminal:
collates the first biometric information stored in the memory with the second biometric information received from the settlement terminal, and
transmits a collation result of the collating to the settlement terminal, and
wherein the settlement terminal.
receives the collation result from each mobile terminal,
specifies the mobile terminal of which the received collation result satisfies a criterion, and
transmits settlement information to the specified mobile terminal.

6. The information processing system according to claim 5, wherein the settlement terminal includes the beacon.

7. An information processing apparatus comprising:
a memory; and
a processor coupled to the memory and configured to:
receive one or more terminal information transmitted from one or more mobile terminal whose position with respect to the computer satisfy a condition;
transmit when first biometric information is captured by the computer, the first biometric information to the one or more mobile terminals based on the one or more terminal information;
specify, when a collation result of collating between the first biometric information and second biometric information stored in each of the one or more mobile terminal is received from the one or more mobile terminal, a mobile terminal of which the received collation result satisfies a criterion among the one or more mobile terminal; and
transmit settlement information to the specified mobile terminal.
